(19) United States
(12) Patent Application Publication
(10) Pub. No.: US 2016/0224307 A1
(43) Pub. Date: Aug. 4, 2016

(54) DEVICE, SYSTEM HAVING SUCH DEVICES, METHOD FOR IMPLEMENTING THE SYSTEM AND COMPUTER PROGRAM PRODUCT FOR IMPLEMENTING THE METHOD

(71) Applicant: SIEMENS AKTIENGESELLSCHAFT, München (DE)

(72) Inventor: Peter Sieger, Gräfelfing (DE)

(21) Appl. No.: 15/023,033

(22) PCT Filed: Sep. 20, 2013
(86) PCT No.: PCT/EP2013/069563

§ 371 Date: Mar. 18, 2016

(51) Int. Cl. G06F 3/14; G06F 3/0484; G06F 3/01; G06F 3/16; G06F 3/0488; G06F 3/041

(52) U.S. Cl. CPC G06F 3/1446; G06F 3/04883; G06F 3/0416; G06F 3/013; G06F 3/017; G06F 3/167; G06F 3/1454; G06F 3/04842; G06F 2203/04104; G09G 5/12

(57) ABSTRACT

The invention relates to a portable electronic device (1; 1a) having a touch screen (2) for displaying images (3), which device has a synchronisation interface (6) for forming a technical system (11) having further devices (1; 1b) of this type, which system makes an overall touch screen (9) that is formed from the individual touch screens (2) of all the devices (1) available for one of the devices (1; 1a). The invention also relates to a technical system (11) formed from devices (1). The invention further relates to a method for forming the technical system (11). Finally, the invention relates to a computer program product for implementing the method.

### CROSS-REFERENCE TO RELATED APPLICATIONS

This application is the National Stage of International Application No. PCT/EP2013/069563, filed Sep. 20, 2013. The entire contents of this document is hereby incorporated herein by reference.

### TECHNICAL FIELD

The present embodiments relate to a portable electronic device, a technical system including such devices, a method for realizing such a technical system, and a computer program product for selectively realizing such a method.

### BACKGROUND

A multiplicity of portable electronic devices including a touch screen for image representations of the device, control of the image representations of the device, and control of the device with the aid of the image representations by touches with and without touch gestures of the touch screen (e.g., with one or a plurality of fingers of a user of the device) are known at the present time. For example, such devices are produced as cellphone, smartphone, iPad, eBook reader, personal digital assistant device (PDA), navigation device, tablet PC and others. Such devices may be controlled by finger indications by one or a plurality of fingers on the touch screen. In this case, use is made not only of simple tapping on the touch screen, but also of touch gestures, such as swiping using the finger on the touch screen. For example, spreading two fingers apart or drawing two fingers together on the touch screen is also possible as an exemplary touch gesture. The result of such touches or touch gestures is corresponding control of the image display or of the functions of the device or of the programs active on the device.

A person skilled in the art is aware of a touch screen as described above with multi-finger gesture recognition paired with corresponding control activities in the associated device in contrast to a simple touch screen without multi-finger gesture recognition as a multi-touch screen. Such a multi-touch screen is known for example from the document US 2008/0168290 A1.

Such devices may now be found in large numbers within a narrowly delimited environment. In this case, all these devices operate autonomously relative to the device itself.

This also applies with regard to the respective touch screens of the respective devices. Furthermore, the touch screens of the individual devices are often very small because the devices themselves are designed to be very small. On the other hand, the intention often is to represent a great deal of image content on the touch screens, resulting in individual representation details turning out to be very small.

For example, if on the touch screen of a relatively small smartphone, with the aid of a soft keyboard displayed in the lower region of the touch screen, text is intended to be input in the upper region of the touch screen, the visible text region is smaller than it would need to be because the image region of the touch screen that is used for the representation of the soft keyboard is no longer available for the text region. Conversely, the region for the representation of the soft keyboard is also reduced and, therefore, the soft keyboard, too, may only be displayed in a correspondingly small fashion. This may be remedied if a separate keyboard that can be connected externally is used, but results in an independent second device and is complex and expensive.

Similar problems exist if contents of browser windows are to be represented on the touch screen, and possibly even with text input as well. Particularly, the image contents of browser windows are often very complex, and so the individual details are represented only in a very small fashion.

The abovementioned soft keyboard constitutes a self-contained control region or image content that is not linked to a fixed position within an image representation. The soft keyboard may possibly also be shifted to a different position. Such self-contained control regions or image contents occur frequently and in a bundled manner in the course of image contents to be represented. However, shifting such self-contained control regions or image contents is possible in each case only within the touch screen is present, and so a magnification of one self-contained control region or image content is always at the expense of the size of the other self-contained control regions or image contents. In order to avoid this problem, it is possible not to alter the size of the other self-contained control regions or image contents, but rather to switch them temporarily into the background and into the foreground as necessary. Disadvantages include the frequent switching and the fact that all image information is not continuously available simultaneously.

Often, a plurality of devices as discussed above are simultaneously active in a narrowly delimited environment, as a so-called standalone device.

The document US 2012/0062442 A1 discloses assembling separate flat screens to form a larger matrix screen. In this case, the flat screens used may also be so-called touch screens which have as separated individual screens a possibility for control of the own image representations for the respective own touch screen by touches with and without touch gestures.

The document US 2012/0062442 A1 additionally discloses interconnecting the flat screens of separate flat screen devices for one of the devices to form a larger flat screen. In that case, the individual flat screen devices may comprise flat screens provided as simple touch screens. The enlarged flat screen obtained may then be used as a simple enlarged touch screen that permits controls by touches with an individual finger, a stylus as a replacement for the individual finger, or with some other suitable part as a replacement for the individual finger.

The document DE 101 27 998 A discloses a modular display for image and/or character reproduction. The display, with regard to its size, may be variably configured to the requirements determined (e.g., by the type of information to be reproduced). The modular display includes a basic module and interconnectable expansion modules. The basic module has a control and image processing unit. The basic module and the expansion modules are pure display modules without control of their own image representations by touches with and without touch gestures.

The document DE 101 27 998 A also discloses a modular display for image and/or character reproduction, said display preferably being provided for reproducing data output by mobile communication devices. The display, with regard to its size, is variably adaptable to the requirements determined (e.g., by the type of information to be reproduced. The display includes of a basic module and interconnectable expansion modules, with the basic module has a control and image processing unit. Electronic devices may be connected to the basic module for magnified image and/or character reproduction, or may have said basic module in a directly integrated manner. For the magnified image and/or character reproduction, the basic module is coupled to the expansion modules. The control and image processing unit of the basic module, based on a data exchange with the coupled expansion modules, identifies the number of display modules joined together and converts the data arriving in the overall display for visualization on the entire display area available for the representation. In contrast to the basic module, the expansion modules do not have their own control and image processing unit, and only include circuit units for data exchange with the basic module.

The document US 2008/0168290 A1 discloses a graphical user interface in an electronic device including a touch screen and a power supply system switch. The graphical user interface includes one or more user interface objects to assist a user in switching off the device to avoid unintentional switch-off events caused by inadvertent contact with the power supply system switch for the touch screen.

### SUMMARY AND DESCRIPTION

The scope of the present invention is defined solely by the appended claims and is not affected to any degree by the statements within this summary.

The present embodiments may obviate one or more of the drawbacks or limitations in the related art. The present embodiments include a device, a technical system including such devices, a method for realizing the technical system, and a computer program product for realizing the method with an altered screen display of an individual device.

In an embodiment, the a device is provided including a synchronization interface for synchronization simultaneously with at least one identical device such that an overall touch screen includes the touch screens of the individual devices synchronized with one another. At least parts of an image representation are representable in a manner controlled by the device on the touch screens of selected identical devices, and synchronized with one another, as originally functional.

It may be pointed out at this juncture that this functionality is always meant when the text mentions: “as originally functional”.

The devices of various embodiments do not necessarily operate only as so-called standalone devices, but rather may operate in an interdisciplinary manner together with other devices. In this way, the components of relevant devices that are present may be used and do not remain present only potentially, owing to their not being used in an interdisciplinary manner.

With regard to the technical system, a plurality of devices may be synchronized with one another such that an overall touch screen includes the touch screens of the individual devices synchronized with one another. At least parts of an image representation of said one device are representable in a manner controlled by said one device on the touch screens of selected devices, synchronized with one another, as originally functional on said one device.

For example, an advantage of such a technical system is that if text is to be input on the touch screen of a device belonging to the technical system with a soft keyboard (e.g., an upper region of the associated touch screen is used for the text and a lower region is used for the representation of the soft keyboard), the soft keyboard is transferable to the touch screen of another device of the technical system and is representable there permanently with maximum magnification, while on the original device the entire touch screen is usable for the text display (e.g., with even more displayable text, with even larger letters, or with both simultaneously). In this case, the soft keyboard is as functional as it was originally functional (e.g., the keyboard still reacts to corresponding finger touches in a corresponding manner).

The soft keyboard is merely representative of arbitrary other logically self-contained control regions or screen display regions. A plurality of regions may also be present simultaneously the same screen display. In such a case, one self-contained control region, one screen display region, or a plurality of such self-contained control regions or screen display regions may be transferred simultaneously to one or a plurality of other devices for display there on the touch screens. Independently of how the self-contained control regions or screen display regions are transferred in a distributed fashion, the regions continue to be made available touch-sensitively for the original device.

Another exemplary embodiment provides for the representation of high resolution images on the touch screen of a relevant device. In the case of coupling touch screens of devices in a system, high resolution images may be drawn across the touch screens of the devices involved in the technical system, either completely or partially with a corresponding magnification effect. The opposite is correspondingly possible. For example, using corresponding touch gestures, such as swiping, rotating, etc., corresponding shifting, turning, tilting and etc. is possible (e.g., entirely as in the case of the original touch screen).

Transfers of relevant screen displays do not necessarily mean that a complete transfer must take place in each case. Transfers may also take place only partly (e.g., only one part of a relevant screen display appears on another touch screen). Concurrently, the other part of a relevant screen is still displayed on the original touch screen. In total, a fluid transfer of relevant self-contained screen display regions between different touch screens is possible, wherein interruptions in the flow of a transfer may also occur.

In an embodiment, a method for realizing the technical system, including devices, is provided. The method includes switching devices into an either active or readiness standby mode for mutual synchronization such that one of the devices is synchronized with another device in an overall touch screen. The overall touch screen includes the touch screens of the individual other devices synchronized with one another such that at least parts of an image representation of said one device are representable in a manner controlled by said one device on the touch screens of selected other devices.

The devices are synchronized with one another, as originally functional, by identifying other devices that are in said active or standby mode, and proceeding from one of the devices, preparing for synchronizing with the other devices that are in said active or standby mode and have been identified as such when proceeding from the one of the devices, synchronizing with the other devices that are in said active or standby mode and have been identified as such when proceeding from the one of the devices, and representing an image arising for a respective device on account of the distributed image representation via the touch screens of the devices, synchronized with one another for this purpose, by the respective device.

Devices carrying out such method acts may form a technical system that uses resources potentially present in the devices that have been used only in a manner relative to individual devices, and the resources are now used by said technical system across devices.

In an embodiment, a computer program product for realizing the method discussed above is provided. The computer program product is used on a device and includes program code forming a computer program for selectively realizing the method.

Such a computer program product has the advantages that it may be handled independently of a device as described above, that at a later point in time it may be applied to a device as described above, or it may be introduced into such a device. Another advantage of the computer program product may be the possibility of the computer program product being used selectively, and that when used by a device, it enables this device to perform the above-described method and that the relevant device, together with corresponding other such devices, may realize the technical system with the above-described advantages associated therewith.

The use of a synchronization interface for wirelessly providing synchronization has the advantage that the synchronization may be carried out independently of a separate connection line, resulting in very free handling of devices present. Moreover, the devices may need not necessarily be positioned in very close mutual proximity. Wireless interfaces may also permit greater distances between the devices.

For wirelessly operating interfaces, use may be made of already known interfaces such as Bluetooth, WLAN (Wireless LAN), ZigBee, NFC (Near Field Communication), Wibree, VLC (Visual Light Communication) or WiMAX interfaces. However, other wireless interfaces are also possible and may be utilized. Furthermore, a plurality of different wireless interfaces may also be used simultaneously. The area of application of the present embodiments is additionally increased thereby.

Wired synchronization interfaces achieve a very high degree of synchronization security, and security in the maintenance of the mutual synchronization.

Known wired interfaces such as a USB interface may be used for this purpose. Other wired interfaces may also be used.

With the aid of a mechanical connection element, individual devices may also be mechanically connected to one another, thus resulting in a device unit having a fixed structure. It may be advantageous if said mechanical connection element is embodied in an articulated fashion. As a result, devices may also be fixed at a predefined angle with respect to one another. If appropriate, the devices may also be handled like a device with a cover.

A mechanical connection element has the further advantage that the connection element may be combined directly with a wired interface.

The present embodiments may be used with devices such as, minicomputers, mobile communication terminals, cellphones, smartphones, iPads, eBook readers, PDAs, navigation devices, tablet PCs or corresponding devices that all have the problem of a small screen display, but are in circulation in very great numbers and often have touch screens.

By providing control of devices synchronized with one another by eye movements, speech and/or body movements, it is possible to use the present embodiments even when corresponding handicaps are present.

If the devices that are used are arranged in a matrix structure, a type of large screen may be realized in this way.

A compact realization of the synchronization and use of relevant devices is provided. The detailed method includes receiving a sender-assignable external readiness signal signaling an external readiness for forming the technical system relative to an own readiness upon arrival of the external readiness signal, outputting a sender-assignable own confirmation signal signaling the reception of an external readiness signal, and receiving an external confirmation signal upon arrival of the external confirmation signal. The method also includes requesting information to be input manually about an optionally specific master or slave assignment and, in the case of a specific slave assignment, about an optionally specific matrix image segment assignment after receipt of at least a single confirmation signal, checking interactively with the knowledge of the senders of received confirmation signals of the assignments of the confirmation signal senders and the own assignment with regard to the presence of only a single master assignment, and requesting, with knowledge of the senders of received confirmation signals, the matrix image segment assignments of the confirmation signal senders in the case of the own master assignment. The method further includes synchronizing interactively the touch screens of the devices outputting confirmation signals to form a single overall touch screen for the device with master assignment depending on the specific master assignment, the specific slave assignments and the specific matrix image segment assignments.

In the case of devices that are switched into a so-called active mode, the following detail method act contributes to realizing synchronization of devices. The method may include outputting a sender-assignable own readiness signal for the signaling of the own readiness for forming a technical system.

In an embodiment, it may be advantageous if method acts take account of fault handling. A method that includes fault handling may include reporting a fault with or without the possibility of correction, and with or without change to a predefined work state at least upon the identification of the presence of more than two master assignments.

It may be advantageous if the synchronized devices interrogate and transfer specific parameters in order that the parameters may be taken into account in the image representation on so-called external devices. Such a situation takes into account the following group method acts, specifically in synchronized devices that have a so-called master assignment and that control an image representation via the overall touch screen obtained by the synchronization. The overall touch screen may be formed by touch screens of technically different devices. The method includes requesting, with knowledge of the senders of received confirmation signals image, representation parameters of the touch screens of the devices assigned to the confirmation signal senders in the case of the own master assignment, dividing an image to be represented at least partly among the individual touch screens of the extended overall touch screen in the case of the own master assignment, and taking into account the image representation parameters of the respective touch screens of the respective devices of the extended overall touch screen upon dividing an image to be represented overall among the individual touch screens of the extended overall touch screen.

### BRIEF DESCRIPTION OF THE DRAWINGS

FIG. 1 depicts a technical device according to an embodiment.

FIG. 2 depicts a technical system according to an embodiment including devices in accordance with FIG. 1 in a combined viewpoint.

FIGS. 3 to 6 depict respective symbols for different states of a device according to the embodiment in accordance with FIG. 1.

FIG. 7 depicts a technical system according to the embodiment including devices in accordance with FIG. 1 in a partial view and first situation.

FIG. 8 depicts a technical system according to an embodiment including devices in accordance with FIG. 1 in a partial view and second situation.

FIG. 9 depicts a general flow diagram with regard to a basic manner of operation of a device according to the embodiment in accordance with FIG. 1.

FIG. 10 depicts a general flow diagram of a first sub-item of the flow diagram in accordance with FIG. 9.

FIG. 11 depicts a general flow diagram of a second sub-item of the flow diagram in accordance with FIG. 9.

FIG. 12 depicts a general flow diagram of a third sub-item of the flow diagram in accordance with FIG. 9.

FIG. 13 depicts a device according to the embodiment in accordance with FIG. 1 in front view and a first operating situation.

FIG. 14 depicts a technical system according to the embodiment formed by two technical devices in accordance with FIG. 1 in front view and a second operating situation.

FIG. 15 depicts a technical system in accordance with FIG. 14 in front view and a third operating situation.

### DETAILED DESCRIPTION

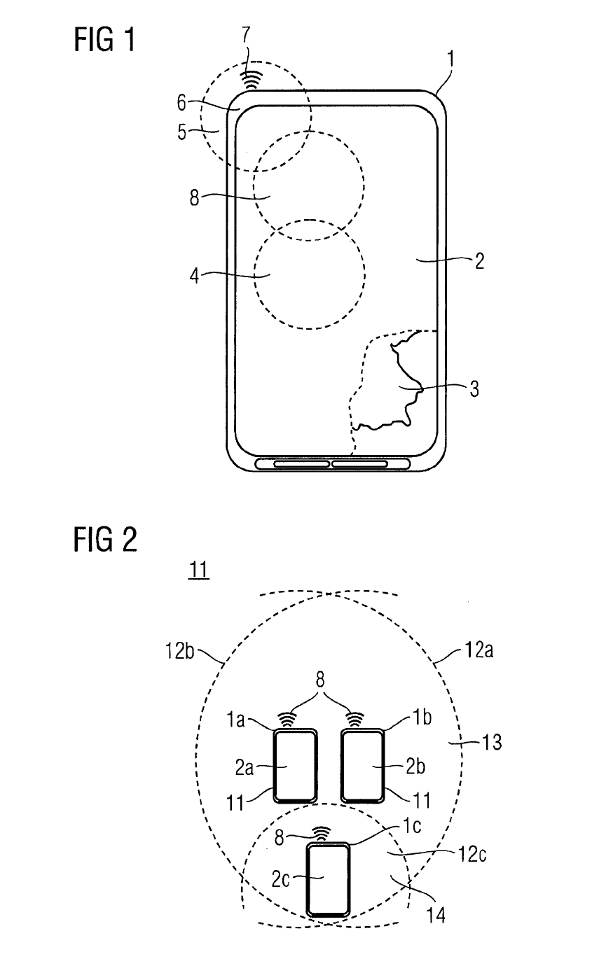

The device 1 depicted in FIG. 1 includes a touch screen 2 for image representation 3 and 4, for the realization per se of image representations 4 on the touch screen 2 and for controls of image representations 3 and/or of the device 1 via the image representations 3 by touches with and without touch gestures of the touch screen 2 (e.g., with one or a plurality of fingers of a user of the device 1). The controls of the image representations 3 and of the device 1 bring about a modification of the image representations 3 and/or operation of the device 1 via the image representations 3.

For example, modification of the image representations 3 provides that image display parts or image display regions of the image representations 3 that are suitable for this purpose may be shifted, magnified, etc. with regard to their spatial positioning on the touch screen 2 (e.g., with finger touches with and without touch gestures such as swiping, tapping, dragging, etc.).

For example, operation of the image representations 3 provides that image display parts or image display regions of the image representations 3 that are suitable for this purpose are also actually used (e.g., with regard to the starting of application programs for example with finger touches, such as double tapping etc. on said parts or regions).

The device 1 also includes a synchronization interface 6 for signal 5. The synchronization interface 6 enables for the device 1 a bidirectional data communication 7 for the purposes of synchronization with at least a single such identical further device 1.

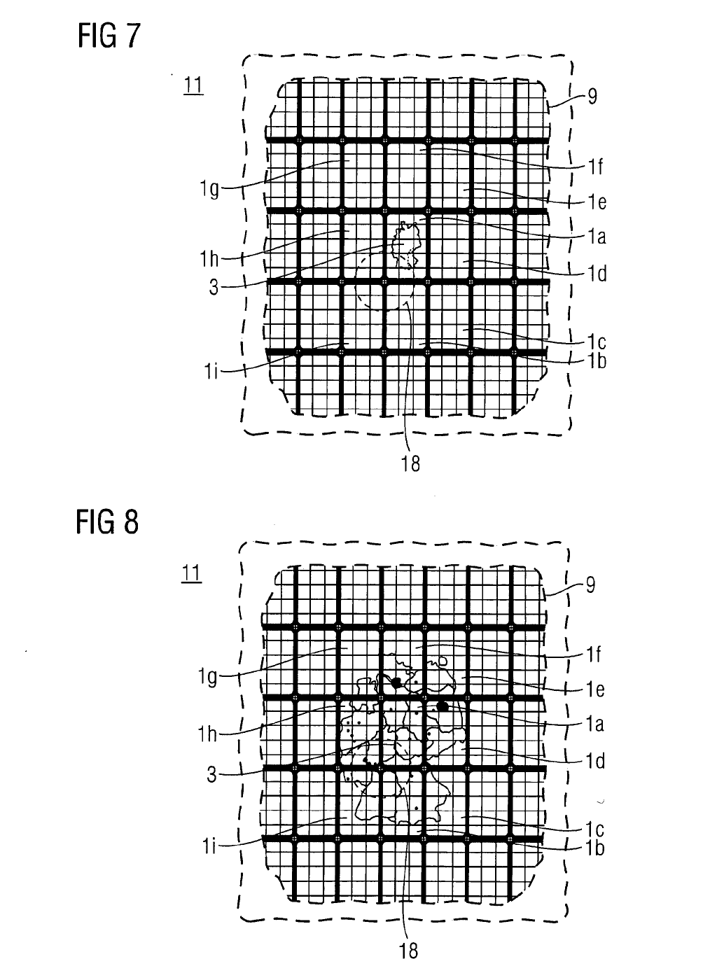

For the realization of said synchronization, the device 1 includes third image representations 8, that, in interaction with the image representations 4 and the signal 5, control the synchronization with at least a single such identical further device 1 such that an overall touch screen 9 (e.g., FIGS. 7 and 8) including the touch screens 2 of the individual devices 1 synchronized with one another is formed for the device 1 such that at least parts of an image representation 3 of the device 1 are representable in a manner controlled by the device 1 on the touch screens 2 of selected identical further devices 1, synchronized with one another, as originally functionally on the device 1.

FIG. 1 depicts a synchronization interface 6 for signal 5, allowing a wireless bidirectional data communication 7.

As examples of such wireless bidirectional data communication interfaces, generally known interfaces include Bluetooth, WLAN, ZigBee, NFC, Wibree, VLC, and/or WiMAX interfaces. Other wirelessly operating interfaces may likewise be used, if appropriate.

The synchronization interface 6 may also be formed instead or additionally for signal 5 in a way that permits a wired bidirectional data communication 7. This case is not illustrated in more specific detail in the drawing.

As an example of such a wired bidirectional data communication interface, a generally known interface includes USB interface. Other interfaces operating in a wired manner may likewise be used, if appropriate.

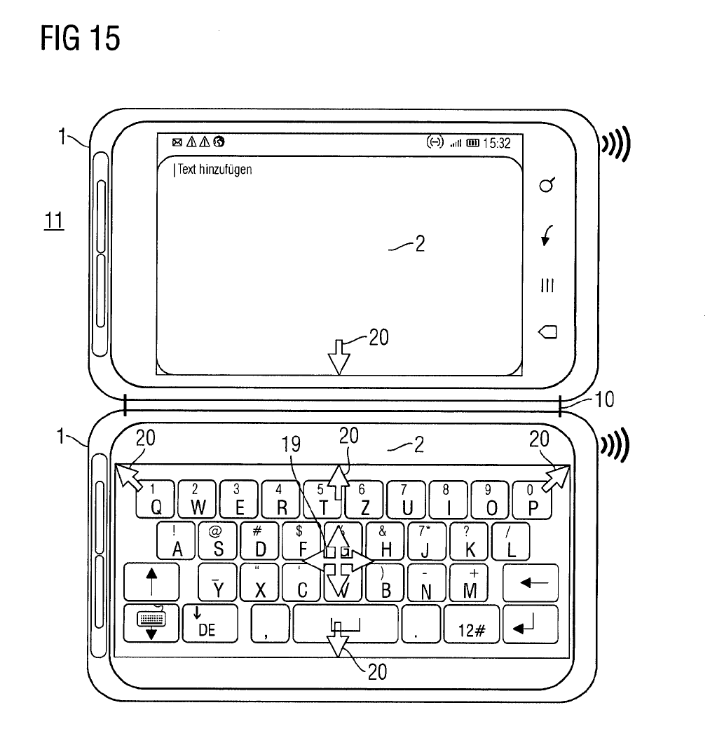

The device 1 may be combined with a mechanical connection element 10 (e.g., FIG. 15), such that a mechanical connection to external components, such as an identical further device 1, may thus be realized.

The abovementioned mechanical connection element 10 may be combined with the wired synchronization interface 6, said wired synchronization interface 6 not being depicted in more specific detail in the drawing. Thus, two different functions are realized by one interface.

By way of example, the minicomputers, mobile communication terminals, cellphones, smartphones, iPads, eBook readers, PDAs, navigation devices, tablet PCs, etc. that are known may serve as basic devices for the formation of devices 1 according to the various embodiments. In the drawing, a smartphone is chosen as such a basic exemplary device.

The device 1 may also comprise an interface suitable for controlling the device 1 using eye movements, speech, body movements, etc. Such interfaces are not explicitly indicated in the present drawing.

FIG. 2 depicts a technical system 11 including above-described devices 1 in a combined view. The technical system 11 depicted in FIG. 2 includes three devices 1, wherein the devices 1 are respective smartphones 1a, 1b and 1c. Each of said devices 1 has, with regard to its synchronization interface 6 for wireless bidirectional data communication 7, a correspondingly wide or less wide wireless transmission range 12a, 12b and 12c. In detail, the transmission range 12a belongs to the device 1a, the transmission range 12b belongs to the device 1b and the transmission range 12c belongs to the device 1c.

Further, as depicted in FIG. 2, the transmission ranges 12a and 12b of the devices 1a and 1b mutually overlap, such that the devices 1a and 1b may respectively carry out a bidirectional data communication 7 in each case to the other device 1b and 1a.

In accordance with FIG. 2, although the device 1c is situated within the transmission ranges of the devices 1a and 1b such that the device 1c may indeed receive the transmissions of the devices 1a and 1b, the transmission range of the device 1c does not extend past the devices 1a and 1b, and so these devices may not receive the transmissions of the device 1c. Therefore, a bidirectional data communication 7 between the devices 1c and 1a, and 1c and 1b, may not be carried out.

As a result, a system 11 according to the various embodiments may be formed by the devices 1a and 1b, but not by the devices 1a and/or 1b and 1c.

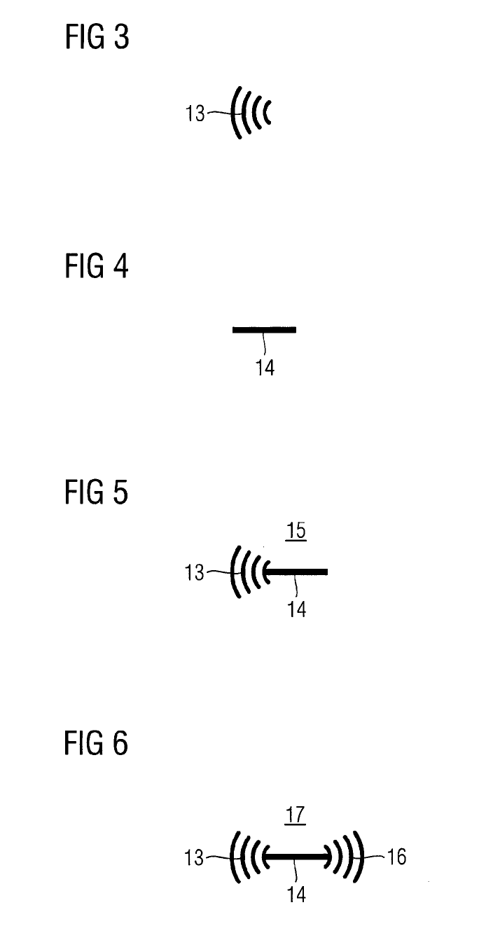

FIGS. 3 to 6 depict examples of symbols that may be displayed on a device 1 and that indicate a possible current status of a device 1 cooperating in a set-up of a technical system according to the various embodiments.

FIG. 3 depicts an example of a first symbol 13 for the status of the device 1 where the device 1 notifies other devices 1 of the readiness to set up a technical system 11 according to the various embodiments.

FIG. 4 depicts an example of a second symbol 14 for the status of the device 1 where device 1 receives from another device 1 the signal indicating the readiness thereof to form a technical system 11 according to the various embodiments.

FIG. 5 depicts an example of a third symbol 15 composed of the first symbol 13 and second symbol 14 for the status of the device 1 where the device 1 is in the process of setting up a connection for a bidirectional data communication 7 with at least a single other device 1 for forming a technical system 11 with said at least a single device 1 according to the various embodiments.

FIG. 6 depicts an example of a fourth symbol 17 including the first symbol 13, the second symbol 14 and the flipped first symbol 16 for the status of the device 1 where the device 1 has set up a connection for a bidirectional data communication 7 with at least a single other device 1 and a technical system 11 with said at least a single device 1 according to the various embodiments.

FIGS. 7 and 8 depict excerpts of a technical system 11 according to the various embodiments including devices 1 in a first (FIG. 7) and second (FIG. 8) configuration. The technical system 11 in FIGS. 7 and 8 is formed by devices 1, with some of the devices 1 designated by the reference signs 1a, 1b, 1c, 1d, 1e, 1f, 1g, 1h and 1i. The technical systems 11 in FIGS. 7 and 8 are identical, such that identically positioned or identically designated devices 1 are the same devices 1. FIGS. 7 and 8 depicts a multiplicity of devices 1 according to the various embodiments for the technical system 11 that is formed thereby. In a minimal configuration, just two devices 1 may be used.

Independently of how many devices 1 are used in the technical system 11, two devices 1 arranged in proximity to one another and synchronized with one another may also be mechanically connected to one another by a mechanical connection element 10 (FIG. 15) with a selectable and/or selected folding angle between them.

The technical system 11 in accordance with FIGS. 7 and 8 includes a plurality of devices 1 synchronized with one another such that for one (e.g., the device 1a) of the devices 1 synchronized with one another an overall touch screen 9 including the touch screens of the individual other devices 1 (e.g., devices 1b to 1i) synchronized with one another is formed such that at least parts of an image representation of said one device 1 (e.g., device 1a) are representable in a manner controlled by said one device 1 (e.g., device 1a) on the touch screens of selected other devices 1 (e.g., devices 1b to 1i) synchronized with one another, as originally functional on the device 1a.

In accordance with FIGS. 7 and 8, the devices 1 are may be arranged in a matrix structure having exact rows and columns, as depicted in the respective figure excerpt 18. Such an alignment is not absolutely necessary. It is also possible for individual matrix positions not to be occupied by devices 1 or for the devices 1 to be freely distributed. Depending on agreement of the devices 1 among one another in the course of their mutual synchronization, image sections assigned to an unoccupied position may be masked out or assigned directly to the closest device 1. Overall, many application structures are conceivable and resolvable by corresponding agreements of the relevant devices 1 among one another.

In the present exemplary embodiment in accordance with FIGS. 7 and 8, the exact matrix structure is chosen. In this case, in FIG. 7 the device 1a displays on its touch-sensitive touch screen an image representation that is functional touch-technologically on said touch screen. Said image representation is relatively small on account of the circumstance that said image representation is displayed only on the one small touch screen.

By virtue of the fact that the device 1a is part of the technical system 11 of the present embodiments and the individual touch screens of the individual devices 1a to 1i may form an overall touch screen 9 for said one device 1a, by correspondingly touching the touch screen or touch screens of the devices 1a to 1i it is possible for the image representation of the device 1a to be drawn beyond the touch screen of the device 1a and thus to be represented anew with corresponding magnification in a manner distributed over the touch screens of the devices 1a to 1i (e.g., FIG. 8). All other types of image manipulation are also conceivable (e.g., turning, etc.). For example, the starting of applications by double tapping on specific locations of the image representation for obtaining additional information may also take place. Furthermore, it is also possible for only individual representation parts or representation regions of an original image representation to be represented anew on other touch screens of the system.

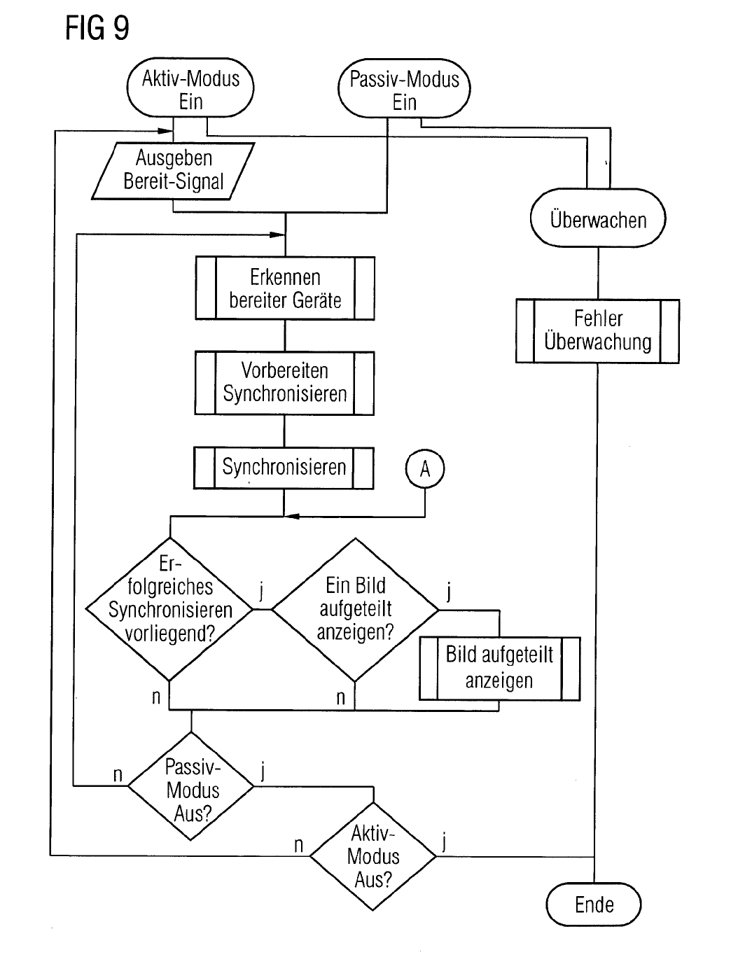

FIG. 9 depicts a general flow diagram for a basic manner of operation of a device 1 according to the various embodiments. The device 1 is switched either into an active mode or into a passive mode with regard to the readiness to form a system 11 according to the various embodiments.

In the active mode, one device 1 emits a signal indicating the readiness to form a technical system 11 with other devices 1. In addition, the device 1 attempts to identify such a signal from other devices 1 that are likewise ready to form the technical system 11.

The devices 1 switched into the passive mode only attempt to identify a signal transmitted by other devices 1 indicating the readiness to form a technical system 11.

A device 1 that is switched neither into said active mode nor into said passive mode is not available for forming the technical system 11.

If a signal is identified by a device 1 that is in said active or passive mode, the relevant device 1 starts the preparation for corresponding synchronization with the relevant other devices.

Corresponding information required by the respective devices to provide the functioning of the technical system 11 is exchanged in the course of preparation for synchronization.

After preparation for synchronization has concluded, the process of synchronization is carried out such that at the end of synchronization a technical system 11 is present where each of the devices 1 belonging to the technical system 11 formed represents images that arise from originally non-distributed image representations on the device 1 on account of distributed image representations over the touch screens 2 of the devices 1 synchronized with one another.

In parallel, successful synchronization may be checked and the outputting of image representations may be enabled only if the synchronization was successful.

If the synchronization was successful and a divided image is intended to be output, the divided image is output. Otherwise, the image representation is left as it is.

A check is made to ascertain whether the passive mode of the relevant device 1 is off. If the passive mode is not off, the relevant device 1 repeats the act of performing the identification of devices 1 ready to form the technical system 11. If the passive mode is off, a check is made to ascertain whether the active mode is off. If the active mode is not off, the relevant device 1 j repeats the act of performing the outputting of the signal indicating the readiness to form the technical system 11. If the active mode is also off, the relevant device 1 is available to form a technical system 11 again only if it is switched into the active or passive mode.

If the check to ascertain a successful synchronization reveals an unsuccessful synchronization, the procedure enters the point of checking whether the passive mode is switched off.

In parallel, with regard to the entire active mode and with regard to the entire passive mode, freedom from faults may be checked and monitored. Corresponding measures for fault correction may be initiated in the event of a fault. If fault correction cannot be initiated, the relevant device 1 may no longer be made available for forming a technical system 11 until the fault has been corrected.

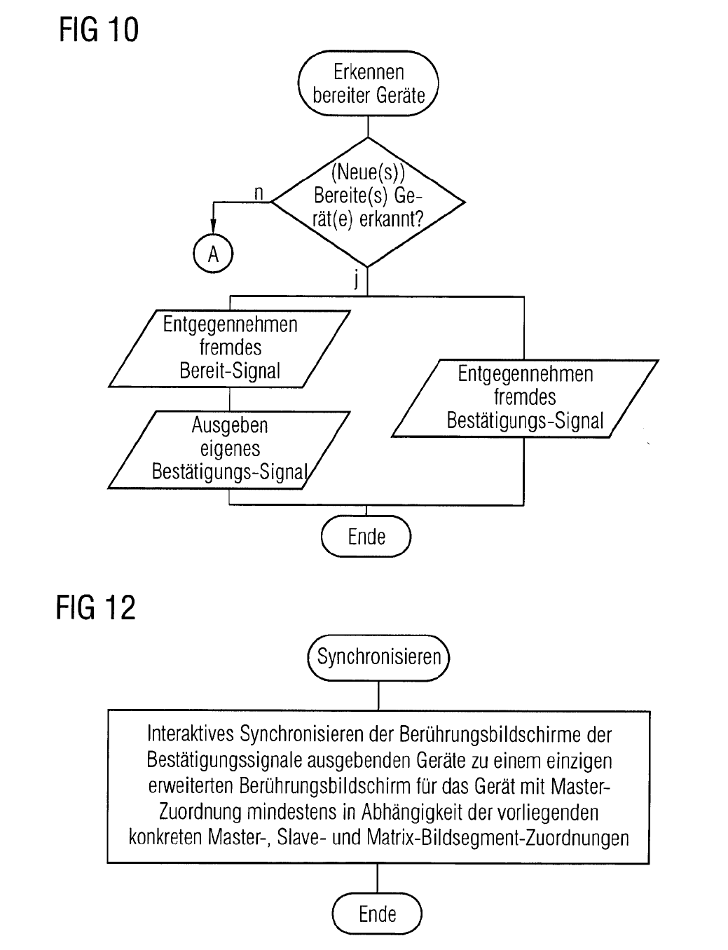

If a relevant device 1 attains the state of identifying devices 1 ready to form the technical system 11 (e.g., as depicted in FIG. 10) a check is made to ascertain whether a device 1 that is ready or newly additionally ready to form the technical system 11 is identified. If this is not the case, the procedure checks whether successful synchronization is present. If such a device 1 is identified, a process of receiving the sender-assignable external readiness signal is performed signaling an external readiness for forming the technical system 11 relative to the own readiness upon arrival of the external readiness signal. Afterward, a process of outputting the sender-assignable own confirmation signal is performed signaling the reception of the external readiness signal. If the identification of ready devices 1 is based on a so-called external device 1 replying with a confirmation signal in response to the own readiness signal, the external confirmation signal is received upon arrival of the external confirmation signal.

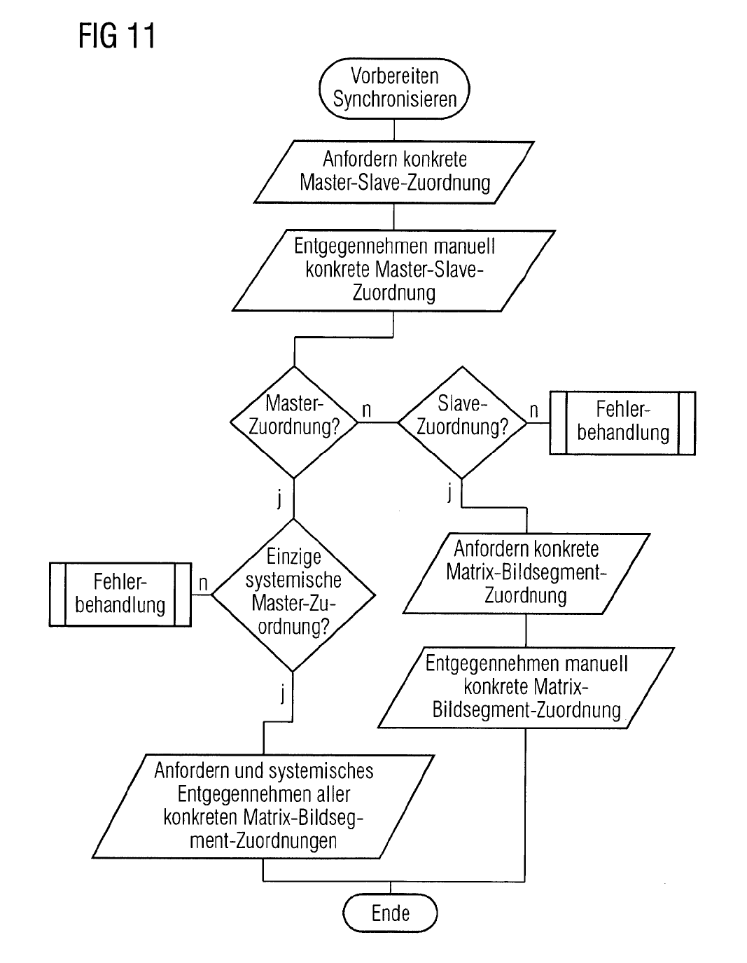

FIG. 11 depicts an example the operating mode of preparing for synchronization. This operating mode involves requesting and receiving information to be input manually about an optionally specific master or slave assignment. In the case of a specific slave assignment, information to be input manually about an optionally specific matrix image segment assignment is requested and received after reception of at least a single confirmation signal. A process of checking interactively with the knowledge of the senders of received confirmation signals of the assignments of the confirmation signal senders and the own assignment with regard to the presence of only a single master assignment is then performed. A process of requesting with knowledge of the senders of received confirmation signals the matrix image segment assignments of the confirmation signal senders in the case of the own master assignment is also performed.

The synchronization operating mode involves synchronizing interactively the touch screens 2 of the devices 1 outputting confirmation signals to form a single overall touch screen 9 for the device 1 with master assignment depending on the specific master assignment, the specific slave assignments and the specific matrix image segment assignments.

When preparing for synchronization, it is possible to check for faults in parallel, where a process of reporting a fault is performed with or without possibility of correction, and with or without change to a predefined work state at least upon identification of the presence of more than two master assignments.

In the case of an own master assignment, when preparing for synchronization, a process of requesting with knowledge of the senders of received confirmation signals image representation parameters of the touch screens 2 of the devices 1 assigned to the confirmation signal senders is performed.

In the case of an own master assignment in the sequence of the main method a process of dividing an image to be represented at least partly among the individual touch screens 2 of the extended overall touch screen 9 is performed. This involves taking into account the image representation parameters of the respective touch screens 2 of the respective devices 1 of the extended overall touch screen 9 upon dividing an image to be represented overall among the individual touch screens 2 of the extended overall touch screen 9.

The relevant devices 1 described in the introduction are equipped or equippable with a computer program product including a computer program formed by program code for selectively realizing the method.

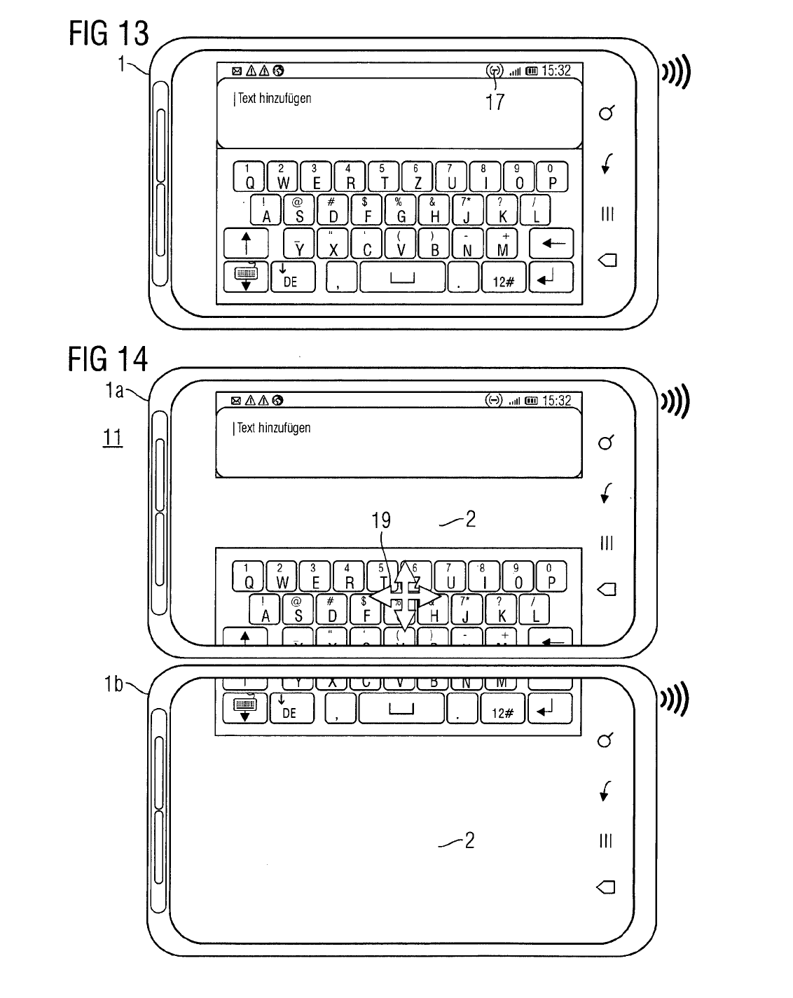

FIG. 13 specifically depicts a device 1 in an elongate horizontal position with a known frequent image representation that includes a lower text input part by a so-called soft keyboard and an upper text display part. As may be identified from a symbol 17 in a topmost image line, the device 1 depicted is in a synchronization with another device 1 (not illustrated in greater detail in FIG. 13), with which it forms a technical system 11 according to the various embodiments.

FIG. 14 depicts the technical system 11 according to the various embodiments as discussed with regard to FIG. 13. In this case, that image representation region of the entire original image representation region that is responsible for text input has already been half shifted out of the touch screen 2 of the original device 1a and into the touch screen 2 of the device 1b, additionally participating in the technical system 11 (e.g., by corresponding finger touches not illustrated per se and are identified only by an arrow cross 19). The arrow cross 19 indicates that said image representation region may be shifted in all directions at the moment.

FIG. 15 depicts the technical system 11 from FIG. 14, where the image representation region responsible for text input has already been completely shifted onto the touch screen 2 of the second device 1b, on which the image representation is operable for the device 1 in a manner usable just like on the original device 1a.

As depicted in FIG. 15, the image representation region responsible for text input has been fitted and drawn across with maximum size on the touch screen 2 of the device 1b. Likewise, the text display part responsible for text display on the original device 1a has been magnified. This has been depicted by expanding arrows 20 in FIG. 15.

In total, both a magnified text display part and a magnified soft keyboard are available.

Many other display possibilities are likewise conceivable.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A portable electronic device comprising:
a touch screen for image representations, the image representations comprising the image representations of the device, control of the image representations of the device and control of the device with the aid of the image representations by touches of the touch screen;
a synchronization interface comprising a signal for synchronization, the signal controlled by one of the image representations simultaneously with at least a single such identical further device such that an overall touch screen comprises the touch screens of the individual devices synchronized with one another is configured for the device, wherein the touch screen comprises multi-finger gesture recognition,
the signal and image representations configured for the synchronization interface for a controlled synchronization simultaneously with at least another identical device such that the overall touch screen comprising the touch screens of the individual devices synchronized with one another is configured for the device such that the overall touch screen for the device is configured to provide multi-finger gesture recognition, and functionality of the control of image representations on the overall touch screen and control of the device with multi-finger gesture control.

2. The device of claim 1, wherein the signal is configured to provide a wireless bidirectional data communication for the purposes of synchronization.

3. The device of claim 2, wherein the synchronization interface comprises Bluetooth, WLAN, ZigBee, NFC, Wibree, WiMAX, VLC, a combination thereof, or another wireless interface.

4. The device of claim 1, wherein the signal comprises a wired bidirectional data communication for the synchronization.

5. The device of claim 4, wherein the synchronization interface comprises a USB or another wired interface.

6. The device of claim 1, further comprising a mechanical connection element configured for mechanical connections to external components.

7. The device of claim 6, wherein the mechanical connection element comprises a wired synchronization interface.

8. The device of claim 1, wherein the device comprises a minicomputer, a mobile communication terminal, a cellphone, a smartphone, an iPad, an eBook reader, a PDA, a navigation device, a tablet PC or another device.

9. The device of claim 1, wherein control of the synchronized devices comprises eye movements, speech, body movements, or a combination thereof.

10. A technical system comprising;
at least two devices configured for mutual synchronization such that an overall touch screen comprising touch screens of the two devices synchronized with one another is provided for one of the devices such that the overall touch screen for the device is configured for multi-finger gesture recognition, control of image representations on the overall touch screen, and control of the device with multi-finger gesture control.

11. The technical system of claim 10, wherein the devices are synchronized a matrix.

12. The technical system of claim 10, wherein the two devices are arranged in proximity of one another, with a selectable folding angle between the devices, or in proximity of one another and with a selected folding angle between the devices.

13. A method for configuring a technical system, the method comprising:
switching devices into an either active or passive mode for mutual synchronization such that one of the devices is synchronized with the other devices in an overall touch screen comprising the touch screens of the other devices the overall touch screen configured for multi-finger gesture recognition for control of image representations on the overall touch screen and control of the one of the devices with multi-finger gesture control,
identifying the other devices in said active or standby mode by the one of the devices,
preparing for synchronizing with the identified other devices,
synchronizing with the identified other devices, and
representing an image representation for each other device for a distributed image representation via the touch screens of the devices.

14. The method of claim 13, further comprising:
receiving a sender-assignable external readiness signal signaling an external standby mode for configuring the technical system (11) relative to standby of the one of the devices upon arrival of the external standby signal,
outputting a sender-assignable confirmation signal of the one of the devices signaling the reception of an external standby signal, and
receiving an external confirmation signal upon arrival of the external confirmation signal.

15. The method of claim 13, further comprising:
requesting information to be input manually about an optional master or slave assignment, wherein for the slave assignment, an optional matrix image segment assignment after reception of at least a single confirmation signal is requested,
checking interactively with knowledge of senders of the received confirmation signals of the assignments of the confirmation signal senders and assignment of the one of the devices with regard to the presence of only a single master assignment, and
requesting, with knowledge of the senders of received confirmation signals, the matrix image segment assignments of the senders for the single master assignment.

16. The method of claim 13, further comprising:
synchronizing interactively the touch screens of the devices outputting confirmation signals for a single overall touch screen for the one of the devices with master assignment depending on a master assignment, slave assignments and matrix image segment assignments.

17. The method of claim 13, wherein at least a single device is switched into the active mode, the method further comprising:
outputting a sender-assignable standby signal for the one of the devices signaling standby for configuring the technical system.

18. The method of claim 15, further comprising:
reporting a fault, with or without a possibility of correction of the fault, and with or without a change to a predefined work state upon identification of the presence of more than two master assignments.

19. The method of claim 15, further comprising:
requesting, with knowledge of senders of received confirmation signals, image representation parameters of the touch screens assigned to the confirmation signal senders for the master assignment of the one of the devices.

20. The method of claim 19, further comprising:
dividing an image to be represented at least partly among the individual touch screens of the extended overall touch screen for the master assignment of the one of the devices.

21. The method of claim 20, further comprising:
using the image representation parameters of the respective touch screens of the respective devices of the extended overall touch screen upon dividing an image to be represented overall among the individual touch screens of the extended overall touch screen.

22. A computer readable storage medium comprising a computer program with program code, which when executed by a processor, is configured to:
display touch screen image representations, the image representations comprising the image representations of a device, control of the image representations of the device and control of the device with the aid of the image representations by touches;
generate a signal for synchronization using a synchronization interface, the signal controllable by one of the image representations simultaneously with at least a single such identical further device such that an overall touch screen comprises the touch screens of the individual devices synchronized with one another is configured for the device, wherein the touch screen comprises multi-finger gesture recognition,
configure the signal and image representations for the synchronization interface for a controlled synchronization simultaneously with at least another identical device such that the overall touch screen comprising the touch screens of the individual devices synchronized with one another is configured for the device such that the overall touch screen for the device is configured to provide multi-finger gesture recognition, and functionality of the control of image representations on the overall touch screen and control of the device with multi-finger gesture control.
